(19) United States
(12) Patent Application Publication
(10) Pub. No.: US 2011/0142129 A1
(43) Pub. Date: Jun. 16, 2011

(54) MPEG VIDEO RESOLUTION REDUCTION SYSTEM

(75) Inventors: Wei-Ying Kung, San Diego, CA (US); Limin Wang, San Diego, CA (US)

(73) Assignee: GENERAL INSTRUMENT CORPORATION, Horsham, PA (US)

(21) Appl. No.: 12/636,177

(22) Filed: Dec. 11, 2009

(51) Int. Cl. H04N 7/32; H04N 7/26

(52) U.S. Cl. 375/240.16; 375/240.01; 375/240.24; 375/240.12; 375/E07.123; 375/E07.243

(57) ABSTRACT

An MPEG video resolution reduction system includes an MPEG decoder, a down-sampler, and a partial MPEG re-encoder. The MPEG decoder decodes an input resolution MPEG stream to an input resolution baseband, and determines coding information from decoding the input resolution MPEG stream. The down-sampler down-samples the input resolution baseband to a reduced resolution baseband. The partial MPEG re-encoder uses the coding information to encode the reduced resolution baseband to a reduced resolution MPEG stream.

### BACKGROUND

ITU-T H.264/MPEG-4 part 10 is an international video coding standard, developed by Joint Video Team (JVT) formed from experts of International Telecommunications Union Telecommunication Standardization Sector (ITU-T) Video Coding Experts Group (VCEG) and International Organization for Standardization (ISO) Moving Picture Experts Group (MPEG). ITU-T H.264/MPEG-4 part 10 is also referred to as MPEG-4 AVC (Advanced Video Coding). In MPEG 4 part 10, an interlaced video frame can be structured and coded (i.e., encoded) as a single frame picture in frame mode, or as a two separate field pictures in field mode. MPEG 4 part 10 allows adaptive switching between frame and field coding mode per frame. MPEG 4 part 10 allows high quality video at lower bit rates without a prohibitive increase in the complexity of applying the standard when compared to previous standards.

Although MPEG 4 part 10 is more efficient than other coding standards, at higher resolutions, the MPEG-4 part 10 streams still requires a large allocation of bandwidth for transmission and space for storage. In some applications, it may not be beneficial to use a high resolution MPEG-4 part 10 stream. Such is the case where limited bandwidth or storage space is available. In these instances, the stream may be converted to a lower resolution. A straightforward approach is fully decode the MPEG4 part 10 stream at high resolution, then down-sample the decoded sequence and fully re-encode the downsampled sequence. However, this straightforward approach is costly in terms of time and processing resources because the re-encoder has to redo the operations, such as motion estimation and code mode decisions per MB, which are very time consuming. As a result, for real-time applications, the required processing resources may be unavailable, or unacceptable, or better allocated to other applications.

### SUMMARY

Disclosed herein is an MPEG video resolution reduction system including an MPEG decoder, a down-sampler, and a partial MPEG re-encoder, according to an embodiment. The MPEG decoder decodes an input resolution MPEG stream to form an input resolution baseband, and determines coding information from decoding the input resolution MPEG stream. The down-sampler down-samples the input resolution baseband to form a reduced resolution baseband. The partial MPEG re-encoder uses the coding information to encode the reduced resolution baseband to form a reduced resolution MPEG stream.

Also disclosed herein is a method for reducing the resolution of an input resolution MPEG stream, according to an embodiment. In the method, the input resolution MPEG stream is received and decoded to form an input resolution baseband. Coding information is determined from decoding the input resolution MPEG stream. The input resolution baseband is then down-sampled to form a reduced resolution baseband. The reduced resolution baseband is encoded to a reduced resolution MPEG stream using the coding information.

Further disclosed is a computer readable storage medium on which is stored one or more computer programs implementing the above-disclosed method for reducing the resolution of an input resolution MPEG stream, according to an embodiment.

Embodiments of the present invention include an MPEG video resolution reduction system including a partial MPEG encoder. The partial MPEG encoder uses decoded coding information, which includes decisions on code modes and motion vectors (MVs) for MPEG-4 part 10, to re-encode an MPEG stream during a video resolution reduction process. This use of decoded coding information reduces encoding costs during the video resolution reduction. For instance, the MPEG video resolution reduction system avoids implementing a complete encoding process, including motion estimation (ME), intra prediction, code mode selection, etc. Because of the resolution reduction, the coding information from the input resolution MPEG stream, such as decoded intra/inter modes, partition types, and MV(s) and reference index (refIdx), may not be directly reused in re-encoding the reduced resolution baseband. However, embodiments of the invention provide a process for using the coding information from the input resolution MPEG stream to encode the reduced resolution baseband to form the reduced resolution MPEG stream.

### BRIEF DESCRIPTION OF THE DRAWINGS

Features of the present invention will become apparent to those skilled in the art from the following description with reference to the figures, in which:

FIG. 1 illustrates a functional block diagram of an MPEG video resolution reduction system, according to an embodiment;

FIG. 2 illustrates a diagram of an example of down-sampling from a high resolution of 720×480 to a low resolution of 352×240, according to an embodiment;

FIG. 3 illustrates a diagram of an example of vertical down-sampling, according to an embodiment;

FIG. 4 illustrates a diagram of four corresponding MBs in a high resolution baseband for a single MB in a low resolution baseband, according to an embodiment;

FIG. 5 illustrates a flow diagram of a method of reducing the resolution of an MPEG stream, according to an embodiment;

FIG. 6 illustrates a flow diagram of a method of reducing the resolution of an MPEG stream, according to an embodiment;

FIG. 7 illustrates a flow diagram of a method of reducing the resolution of an MPEG stream, according to an embodiment;

FIG. 8 illustrates a diagram of a mapping of refIdx from an old reference list to a new reference list, according to an embodiment;

FIG. 9 illustrates a diagram of a mapping of refIdx from an old reference list to a new reference list, according to an embodiment;

FIG. 10 illustrates a diagram of a mapping of refIdx from an old reference list to a new reference list, according to an embodiment;

FIG. 11 illustrates a diagram of a motion vector pool per MB partition, according to an embodiment;

FIG. 12 illustrates a diagram of a motion vector pool per MB partition, according to an embodiment;

FIG. 13 illustrates a diagram of a motion vector pool per MB partition, according to an embodiment;

FIG. 14 illustrates a diagram of a motion vector pool per MB partition, according to an embodiment; and

FIG. 15 illustrates a simplified block diagram of architecture of an

MPEG video resolution reduction system, according to an embodiment.

### DETAILED DESCRIPTION

For simplicity and illustrative purposes, the present invention is described by referring mainly to exemplary embodiments thereof. In the following description, numerous specific details are set forth to provide a thorough understanding of the present invention. However, it will be apparent to one of ordinary skill in the art that the present invention may be practiced without limitation to these specific details. In other instances, well known methods and structures have not been described in detail to avoid unnecessarily obscuring the present invention.

### 1. Video Resolution Reduction System

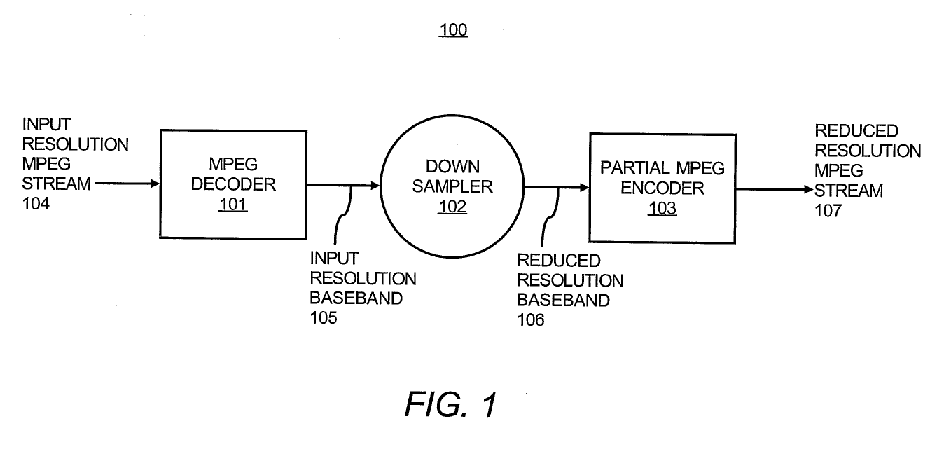

FIG. 1 illustrates a functional block diagram of an MPEG video resolution reduction system 100 configured to reduce the resolution of an input resolution MPEG stream 104, according to an embodiment. The input resolution MPEG stream 104 may be an MPEG stream. The MPEG stream may be an MPEG-4 Part 10 stream. Although the system 100 is described with respect to MPEG and MPEG-4 Part 10 in particular, the system 100 may be used for other standards. As shown in FIG. 1, the MPEG video resolution reduction system 100 includes an MPEG decoder 101, a down-sampler 102, and a partial MPEG encoder 103.

The MPEG decoder 101 decodes the input resolution MPEG stream 104 to form an input resolution baseband 105. Baseband refers to a decoded stream. The MPEG decoder 101 also determines coding information from decoding the input resolution MPEG stream 104. For instance, the MPEG decoder 101 collects the coding information as the input resolution MPEG stream 104 is decoded.

The MPEG decoder 101 receives the input resolution MPEG stream 104. According to an embodiment, the input resolution MPEG stream 104 may comprise a video stream, broadcast in an MPEG-4 part 10 format. The MPEG decoder 101 decodes the input resolution MPEG stream 104 to produce the input resolution baseband 105. The input resolution baseband 105 includes decoded pictures from the video stream. In the process of decoding the input resolution MPEG stream 104 to form the input resolution baseband 105, the MPEG decoder 101 also determines the coding information for the input resolution MPEG stream 104. The coding information determined during the process of decoding the input resolution MPEG stream 104 may include a code mode and motion vectors (MVs) and associated refIdx for each macroblock (MB) from the input resolution MPEG stream 104. The refIdx is an index into a reference picture list used in ME. The MPEG decoder 101 thereafter outputs the input resolution baseband 105 to the down-sampler 102.

The down-sampler 102 down-samples the input resolution baseband 105 to form a reduced resolution baseband 106. The resolution is a number of distinct pixels in each dimension of a frame or field that can be displayed. The reduced resolution baseband 106 has a lower resolution than the input resolution baseband 105. An example of the reduced resolution is described in detail below.

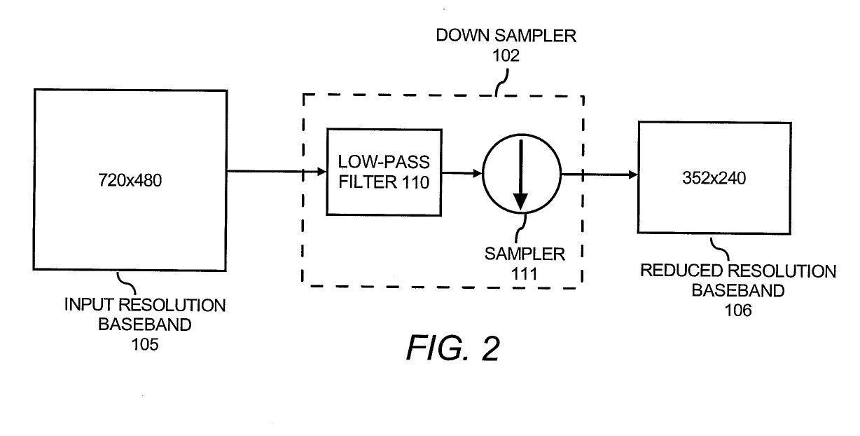

To simplify discussions, as described with respect to examples in FIGS. 2 to 4, resolution reduction is set to a factor of 2, both horizontally and vertically. It should be understood that the following example of down-sampling using the down-sampler 102 and encoding thereafter using the partial MPEG encoder 103, as described with respect to FIGS. 2 to 4, is illustrative and the system 100 may down-sample to other resolutions. The down-sampler 102 and the partial MPEG encoder 103 in the MPEG video resolution reduction system 100 may be used to reduce the resolution of the input resolution MPEG stream 104 by other factors, horizontally and/or vertically.

The partial MPEG encoder 103 encodes the reduced resolution baseband 106 using the coding information to form a reduced resolution MPEG stream 107. This encoding is a re-encoding of the stream 104, but at a lower resolution. It should be understood that the MPEG video resolution reduction system 100 depicted in FIG. 1 may include additional components and that some of the components described herein may be removed and/or modified without departing from a scope of the MPEG video resolution reduction system 100.

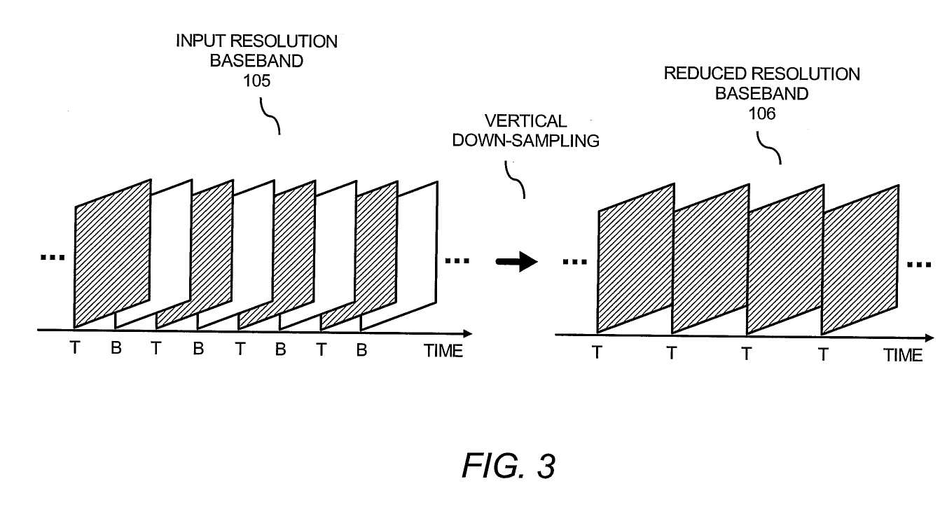

FIG. 2 shows an example of the down sampler 102 down-sampling the resolution of the input resolution baseband 105 from a 480i standard definition (SD) resolution of 720×480 to a 240p standard image format (SIF) resolution of 352×240 for the reduced resolution baseband 106. A 480i SD frame consists of two fields sampled at different time instants. Vertical down-sampling is achieved, for example, by discarding one of two fields per decoded 480i SD frame. For example, in FIG. 3, all top fields (T) are retained while all bottom fields (B) are dropped in the new resolution. Horizontal resolution reduction is achieved, for example, by a low pass filter 110 low-pass filtering horizontal pixels of the decoded pictures and then sampler 111 down-sampling the low-pass filtered pixels by a factor of 2.

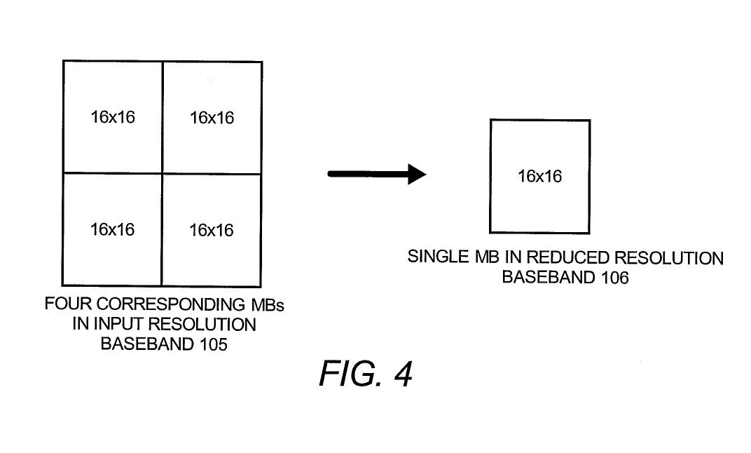

By down-sampling by a factor of 2 both horizontally and vertically, four neighbor MBs in the input resolution resolution baseband 105 are mapped into a single MB in the reduced resolution baseband 106, as shown in FIG. 4. The four neighbor MBs in the input resolution baseband 105 and the single MB in the reduced resolution baseband 106 correspond to a same area in a picture or image. The single MB is used in the reduced resolution MPEG stream 107 to display in reduced resolution the same part of the image as the four MBs in the input resolution MPEG stream 104. The down-sampler 102 may down-sample the input resolution baseband 105 by other factors, vertically and/or horizontally, so that the single MB in the reduced resolution baseband may be mapped into different numbers of MBs in the input resolution MPEG stream 104. The down-sampler 102 thereafter outputs the reduced resolution baseband 106 to the partial MPEG encoder 103.

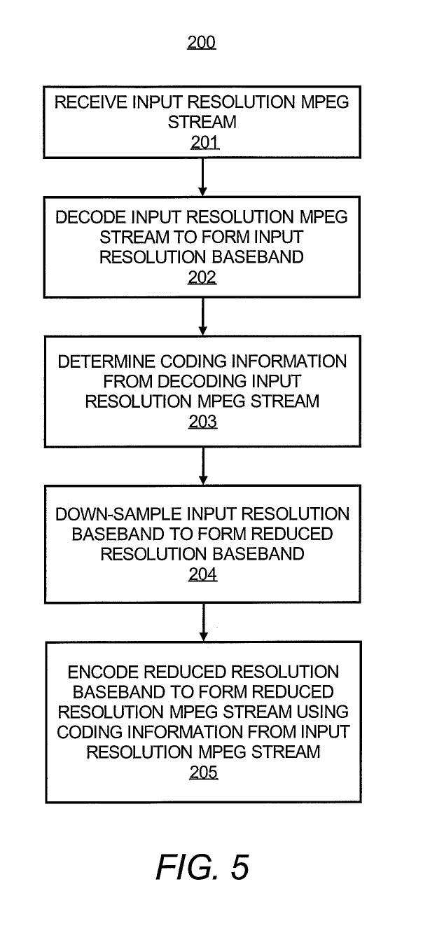

The partial MPEG encoder 103, shown in FIG. 1, then encodes the reduced resolution baseband 106 to form the reduced resolution MPEG stream 107. With regard to FIG. 4, each of the four decoded MBs in the input resolution baseband 105 may have separate coding information including intra mode or inter mode, partition type, and an MV or MVs and refIdx. The partial MPEG encoder 103 determines intra mode or inter mode, and performs MV and refIdx scaling based on corresponding MBs in the input resolution MPEG stream 104, as will be described hereinbelow with respect to FIGS. 5 to 7 and the methods 200 to 220.

It will be apparent that the MPEG video resolution reduction system 100 may include additional elements not shown and that some of the elements described herein may be removed, substituted and/or modified without departing from the scope of the MPEG video resolution reduction system 100. It should also be apparent that one or more of the elements described in the embodiment of FIG. 1 may be optional.

### 2. Reducing Resolution of MPEG Stream

Examples of methods in which the MPEG video resolution reduction system 100 may be employed to reduce the resolution of an MPEG stream now be described with respect to the following flow diagrams of the methods 200-220 depicted in FIGS. 5-7. It should be apparent to those of ordinary skill in the art that the methods 200-220 represent generalized illustrations and that other steps may be added or existing steps may be removed, modified or rearranged without departing from the scopes of the methods 200-220. In addition, the methods 200-220 are described with respect to the MPEG video resolution reduction system 100 by way of example and not limitation, and the methods 200-220 may be used in other systems.

Some or all of the operations set forth in the methods 200-220 may be contained as one or more computer programs stored in any desired computer readable medium and executed by a processor on a computer system. Exemplary computer readable media that may be used to store software operable to implement the present invention include but are not limited to conventional computer system RAM, ROM, EPROM, EEPROM, hard disks, or other data storage devices.

The method 200, as shown in FIG. 5, is a generalized illustration of a method of using the MPEG video resolution reduction system 100 to reduce the resolution of an MPEG stream.

At step 201, as shown in FIG. 5, the MPEG video resolution reduction system 100 receives the input resolution MPEG stream 104 at the MPEG decoder 101.

At step 202, the MPEG decoder 101 decodes the input resolution MPEG stream 104 to form an input resolution baseband 105. At step 203, in the process of decoding the input resolution MPEG stream 104, the MPEG decoder 101 determines coding information from decoding the input resolution MPEG stream 104. The coding information includes intra mode or inter mode, partition type, and an MV or MVs and refIdx for each MB. The MPEG decoder 101 then outputs the input resolution baseband 105 to the down-sampler 102.

At step 204, the down-sampler 102 down-samples the input resolution baseband 105 to form a reduced resolution baseband 106. The down-sampler may vertically down-sample the input resolution baseband 105 by discarding fields and horizontally down-sample the input resolution baseband 105 by first low pass filtering the input resolution baseband and then down-sampler by a predetermined factor, for instance a factor of 2, as described hereinabove with regard to FIGS. 2 to 4 and the down-sampler 102. The down-sampler 102 thereafter outputs the reduced resolution baseband 106 to the partial MPEG encoder 103.

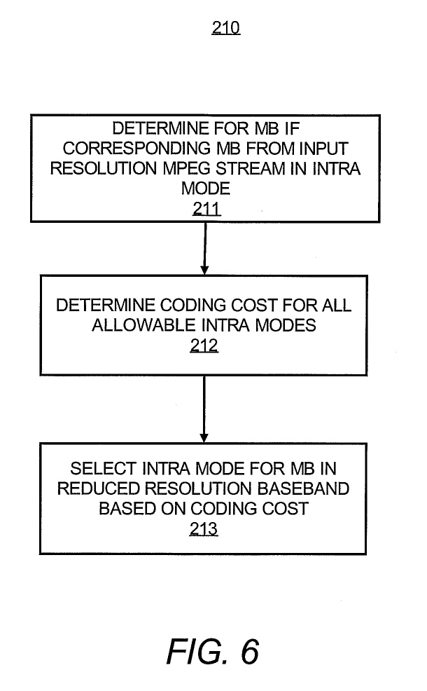

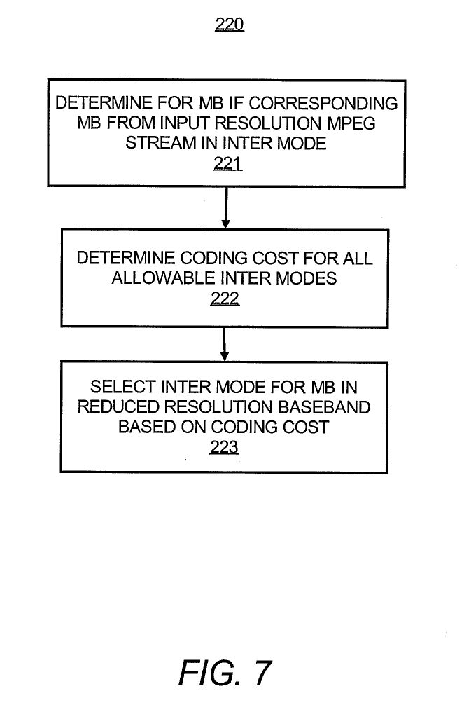

At step 205, the partial MPEG encoder 103 encodes each MB in the reduced resolution baseband 106 to form a reduced resolution MPEG stream 107 using the coding information from decoding the input resolution MPEG stream 104. The partial MPEG encoder 103 may determine code modes and other parameters per MB from the decoded MBs in the input resolution MPEG stream 104 for a corresponding MB in the reduced resolution MPEG stream 107. The other parameters include partition type, and MV(s) and refIdx per MB as described hereinbelow with respect to FIGS. 6-14 and the method 220. The code modes include a minimum coding cost intra mode and a minimum coding cost inter mode per MB as described hereinbelow with respect to FIG. 6 and the method 210, and FIG. 7 and the method 220.

Thereafter, the partial MPEG encoder 103 may determine a minimum coding cost mode using the minimum coding cost intra mode and the minimum coding cost inter mode for the MB. The partial MPEG encoder 103 encodes the MB in the reduced resolution baseband 106 using the minimum coding cost mode, for example the minimum coding cost intra mode in instances in which the minimum coding cost intra mode is lower than the minimum coding cost inter mode for the MB. The reduced resolution baseband 106 (or a picture) may contain many MBs. Some of the MBs may be encoded in intra mode and other MBs in inter mode.

The method 210, as shown in FIG. 6, is a generalized illustration of a method of determining an intra mode for an MB in the reduced resolution baseband 106. The method 210 may be applied at step 205 of the method 200 to determine the coding cost for intra modes in the reduced resolution baseband 106.

At step 211, the partial MPEG encoder 103 determines for the MB in an area in the reduced resolution baseband 106 whether a corresponding MB or MBs in the input resolution baseband 105 is in intra mode. For instance, if the reduced resolution baseband 106 has been down-sampled by a factor of 2, vertically and horizontally, the corresponding area covers four MBs in the input resolution baseband 105, as shown in FIG. 4. The partial MPEG encoder 103 determines whether any of the four MBs are in intra mode.

The MB in the reduced resolution baseband 106 is encoded in either intra mode or inter mode, which is determined from the coding information. Coding refers to encoding. If at least one of the MBs in the corresponding area is encoded in inter mode, then method 220 shown in FIG. 7 is performed. If at least one of the MBs in the corresponding area is encoded in intra mode, then step 212 is performed.

At step 212, in response to a determination that there is a corresponding MB in intra mode, the partial MPEG encoder 103 determines a coding cost for all allowable intra modes for the MB in the reduced resolution baseband 106. All allowable intra modes include intra_{—}4×4, intra_{—}8×8 (if high profile), and intra_{—}16×16.

At step 213, the partial MPEG encoder 103 selects an intra mode for the MB in the reduced resolution baseband 106 based on the coding cost. For instance, the partial MPEG encoder 103 selects a minimum coding cost intra mode for the intra mode for the MB in the area in the reduced resolution baseband 106. Thereafter as described hereinabove with respect to step 205 of the method 200 and FIG. 5 hereinabove, the partial MPEG encoder 103 may use the minimum coding cost intra mode to select a minimum coding cost mode.

The method 220, as shown in FIG. 7, is a generalized illustration of a method of determining an inter mode for an MB in the reduced resolution baseband 106. The method 220 may be applied at step 205 of the method 200 to determine the inter mode for the MB in the reduced resolution baseband 106.

At step 221, the partial MPEG encoder 103 determines for each MB in an area in the reduced resolution baseband 106 whether there is a corresponding MB in inter mode. The corresponding MB in inter mode is an MB or MBs in inter mode in a corresponding area in the input resolution baseband 105. For instance, if the reduced resolution baseband 106 has been down-sampler by a factor of 2, vertically and horizontally, the corresponding area covers four MBs in the input resolution baseband 105, as shown in FIG. 4. The partial MPEG encoder determines whether any of the four MBs are in inter mode.

At step 222, in response to a determination that there is a corresponding MB in inter mode, the partial MPEG encoder 103 determines a coding cost for all allowable inter modes for the MB in the reduced resolution baseband 106. All allowable inter modes may include inter_{—}16×16, inter_{—}16×8, inter_{—}8×16, and inter_{—}8×8.

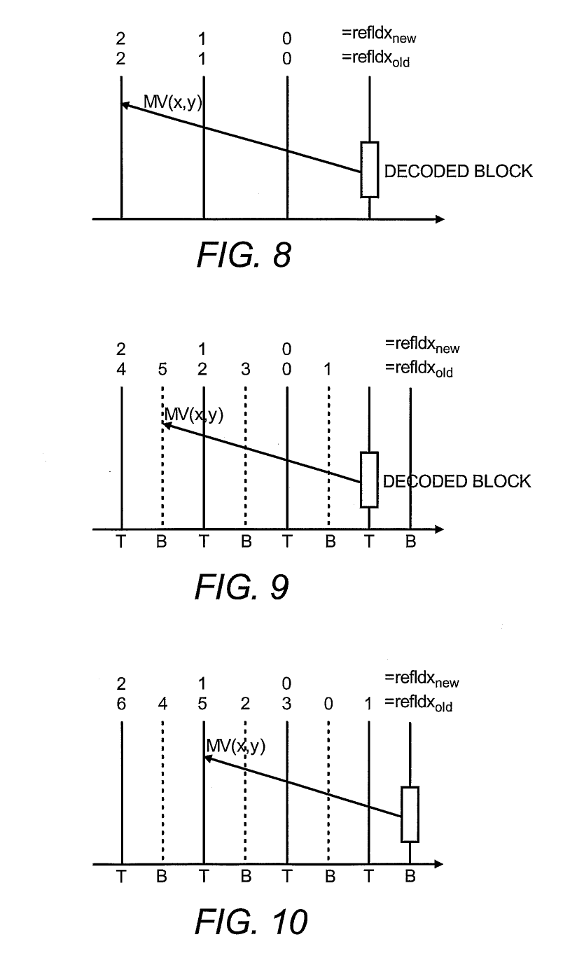

The partial MPEG encoder 103 determines a starting MV(s) for a refIdx for a single MB in the reduced resolution baseband 106 from a decoded MV(s) and associated refIdx from the corresponding MBs in the input resolution baseband 105, for instance as described hereinbelow with regard to FIGS. 8 to 14. The partial MPEG encoder 103 performs this process for all allowable inter modes to determine the coding cost. The decoded MV(s) and associated refIdx in the input resolution baseband 105 are scaled to the reduced resolution baseband 106.

Thereafter, the partial MPEG encoder 103 performs only ME refinement over reference pictures indexed by refIdx for the MB in the reduced resolution baseband 106. The partial MPEG encoder 103 may perform ME refinement at quarter-pel resolution. The range of ME refinement may vary from +/−0 to any number. Once 0 is set, ME refinement only checks the starting MVs. The partial MPEG encoder 103 thereby avoids a time-consuming full ME process when determining the coding cost for inter modes for an MB in the reduced resolution baseband 106.

At step 223, the partial MPEG encoder 103 selects an inter mode for the MB in the reduced resolution baseband 106 based on the coding cost. For instance, the partial MPEG encoder 103 selects a minimum coding cost inter mode for the inter mode for the MB in the area in the reduced resolution baseband 106. Thereafter as described hereinabove with respect to step 205 of the method 200 and FIG. 5 hereinabove, the partial MPEG encoder 103 may use the minimum coding cost inter mode to select a minimum coding cost mode.

### 3. Determining Motion Vectors and RefIdx Scaling

The following discussion is illustrative of one process by which the MVs and refIdx may be scaled from an old resolution, for example the input resolution, to a new resolution, for example the reduced resolution, as discussed at step 223 of the method 220 hereinabove. The example is limited to a factor of 2. It should be understood that the MPEG video resolution reduction system 100 may be used to reduce the resolution of an input resolution MPEG stream 104 by other factors.

The MPEG decoder 101 and the partial MPEG encoder 103 perform over different resolutions in the MPEG video resolution reduction system 100. The decoded MV(s) and refIdx in the old resolution, for instance a resolution in the input resolution MPEG stream 104, and an old reference list(s) are therefore first scaled down to the new resolution, for instance a resolution in the reduced resolution MPEG stream 107, and a new reference list(s).

According to an embodiment, assume that the reference list(s) are in default order, and that the second fields are dropped when reducing from SD resolution to SIF resolution. Let MV(x_{old}, y_{old}) be the decoded MV in the old resolution, where x_{old} and y_{old} are respectively the horizontal and vertical components, and refIdx_{old} the associated reference index. Let MV(x_{new}, y_{new}) be the derived MV in the new resolution, where x_{new} and y_{new} are respectively the horizontal and vertical components, and refIdx_{new} be the associated reference index.

If the decoded MB in the old resolution is frame coded, as shown in FIG. 8, the decoded reference indices, refIdx_{old}, can maintain unchanged when mapping from the old reference list(s) to the new reference list(s), that is,

refIdx_{new}=refIdx_{old} Equation (1)

The decoded MV(s), MV_{old}(x, y), however need to be scaled down to the new resolution by dividing both the horizontal and vertical components by a factor of 2, that is,

MV(x_{new}, y_{new})=MV(x_{old}/2, y_{old}/2). Equation (2)

If the decoded MB in the old resolution is field coded and if it is not in a decoded second P field, as shown in FIG. 9, the decoded reference indices, refIdx_{old}, generally need to be divided by a factor of 2 when mapping from the old reference list(s) to the new reference list(s), that is,

refIdx_{new}=refIdx_{old}/2. Equation (3)

The decoded MV(s), MV(x_{old}, y_{old}), need to first be extended to the closest existing reference field, if the reference picture indexed by refIdx_{old} has been dropped in the new reference list(s), and then be scaled down to the new resolution by dividing the horizontal component only by a factor of 2, that is,

$$MV ( {x}_{new} , {y}_{new} ) = MV ( ( {x}_{old} \times \frac{{T}_{new}}{{T}_{old}} ) / 2 , {y}_{old} \times \frac{{T}_{new}}{{T}_{old}} ) \qquad Equation ( 4 )$$

in which T_{new} and T_{old} and are the temporal distances between the decoded MB and the reference pictures indexed by refIdx_{new} and refIdx_{old}, respectively.

If the decoded MB in the old resolution is field coded and it is in a decoded second P field, as shown in FIG. 10, mapping of the decoded reference index, refIdx_{old}, from the old reference list(s) into the new reference list(s) depends upon the values of refIdx_{old}. Specifically, the reference index of a decoded MB partition in a decoded second P field, refIdx_{old}, is mapped into the new reference list(s) as

$${refIdx}_{new} = \{ \begin{matrix}0 & {refIdx}_{old} = 1 \\ {refIdx}_{old} / 2 - 1 & \begin{matrix}{refIdx}_{old} = \\ 2 \times num\_ref \_frames\end{matrix} \\ {refIdx}_{old} / 2 - {refIdx}_{old} \%2 & if others .\end{matrix} \qquad Equation ( 5 )$$

The decoded MVs, MV(x_{old}, y_{old}), are mapped into the new resolution, where the new horizontal component and vertical components are determined as

$$MV ( {x}_{new} , {y}_{new} ) = MV ( ( {x}_{old} \times \frac{{T}_{new}}{{T}_{old}} ) / 2 , {y}_{old} \times \frac{{T}_{new}}{{T}_{old}} ) . \qquad Equation ( 6 )$$

For reference list(s) that are not in the default order, the principle of mapping the decoded reference indices from the old reference list(s) into the new reference list(s) stays the same.

When determining the coding cost of an inter mode for a current MB in the new resolution, a specific mode, say DIRECT mode or inter_N×M, where N, M=16 and 8, may be one of the decoded inter modes for the four MBs in the corresponding area in the old resolution, or not. If inter_N×M, where N, M=16 and 8, is one of the decoded inter modes for the four MBs in the old resolution, the partial MPEG encoder 103 determines the coding cost for inter_N×M along with MV(x_{new}, y_{new}), and refIdx_{new} to the corresponding MB in the new resolution. If inter_N×M, where N, M=16 and 8, is not one of the decoded inter modes for the four MBs in the old resolution, the partial MPEG encoder 103 still determines the coding cost for inter_N×M for the corresponding MB in the new resolution, but over all the allowable reference pictures in the new reference list(s).

Specifically, given a current reference picture in the new reference list(s) indexed by refIdx_{cur}, the partial MPEG encoder 103 will further extend all the scaled MV(s), MV(x_{new}, y_{new}), of the four MBs in the old resolution to the reference picture indexing by refIdx_{cur} as

$${MV}_{cur} ( x , y ) = {MV}_{new} ( x \times \frac{{T}_{cur}}{{T}_{new}} , y \times \frac{{T}_{cur}}{{T}_{new}} ) , \qquad Equation ( 15 )$$

in which T_{cur} and T_{new} are the temporal distances between the decoded MB and the reference pictures indexed by refIdx_{cur} and refIdx_{new}, respectively.

The starting MV over the current reference picture indexed by refIdx_{cur} for a current MB partition in the new resolution is set to equal to the median, mean, mode, or other statistics of these further extended scaled MV(s), MV_{cur}(x, y), of the corresponding MBs in the old resolution, that is,

MV(x, y)=median{MV_{cur}(x, y)}, Equation (16)

or

MV(x, y)=mean{MV_{cur}(x, y)} Equation (17)

or

MV(x, y)=mode{MV_{cur}(x, y)} Equation (18)

or

MV(x, y)=statistics_measure{MV_{cur}(x, y)}. Equation (19)

The starting MV per MB partition can vary from one reference picture to another reference picture, or the starting MV is a function of refIdx_{cur}.

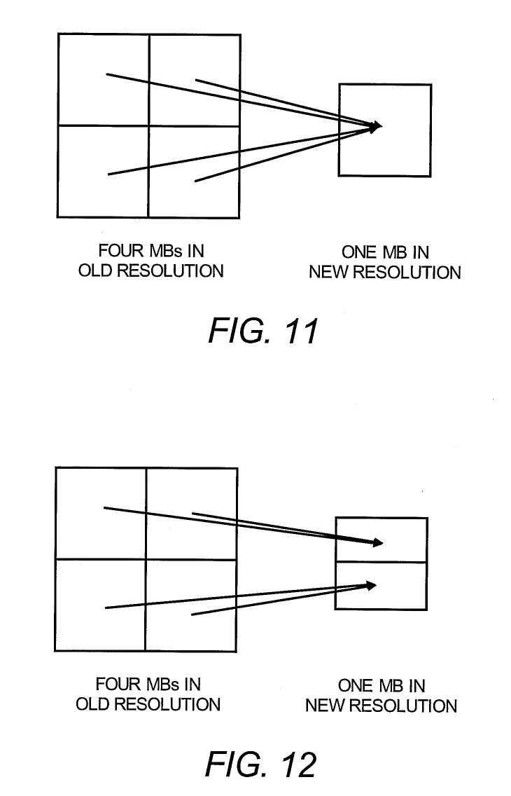

The partial MPEG encoder 103 also determines an MV pool per MB partition. For inter_{—}16×16 in the new resolution, the MV pool in calculating the median, mean, mode, or other statistics includes all the further extended scaled MV(s), MV_{cur}(x, y), in the four decoded MBs in the old resolution, as shown in FIG. 11.

For inter_{—}16×8 in the new resolution, for the top 16×8 partition, the MV pool includes all the further extended scaled MV(s), MV_{cur}(x, y), of the top two decoded MBs in the old resolution, and for bottom 16×8 partition, the MV pools include all the extended scaled MV(s), MV_{cur}(x, y), of the bottom two decoded MBs in the old resolution, as shown in FIG. 12.

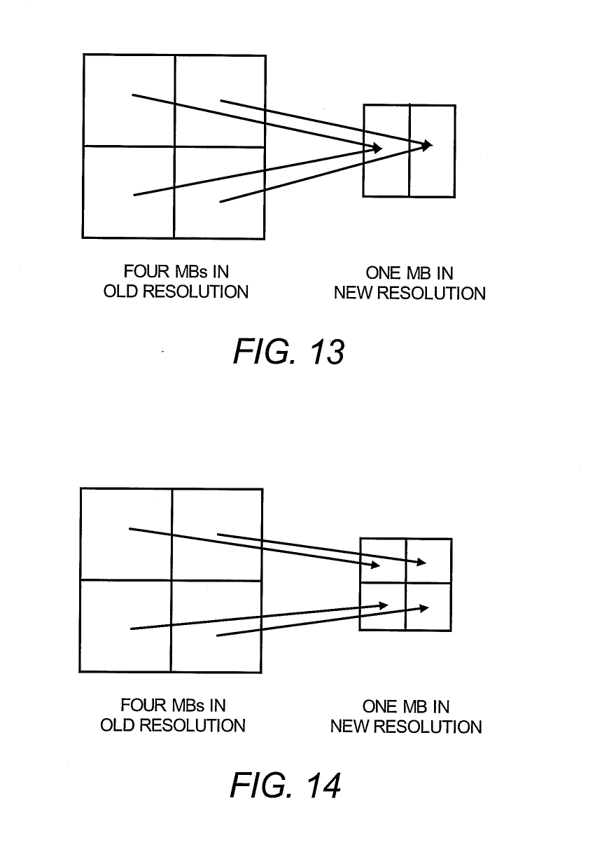

For inter_{—}8×16 in the new resolution, for the left 8×16 partition, the MV pool includes all the extended scaled MV(s), MV_{cur}(x, y), of the left two decoded MBs in the old resolution, and for the right 8×16 partition, the MV pools include all the extended scaled MV(s), MV_{cur}(x, y), of the right two decoded MBs in the old resolution, as shown in FIG. 13.

For inter_{—}8×8 in the new resolution, for the top-left 8×8 partition, the MV pool includes all the extended scaled MV(s), MV_{cur}(x, y), top-left decoded MB in the old resolution, for the top-right 8×8 partition, the MV pool includes all the extended scaled MV(s), MV_{cur}(x, y), of the top-right decoded MB in the old resolution, for the bottom-left 8×8 partition, the MV pools include all the extended scaled MV(s), MV_{cur}(x, y), of the bottom-left decoded MB in the old resolution, and for the bottom-right 8×8 partition, the MV pools include all the extended scaled MV(s), MV_{cur}(x, y), of the bottom-right decoded MB in the old resolution, as shown in FIG. 14.

For each of code modes (intra/inter, partition type, and MV(s) and refIdx) for an MB in the reduced resolution MPEG stream 107, the partial MPEG encoder 103 calculates a rate distortion (RD) coding cost, defined as

cost=D+λ×R Equation (20)

in which D and R are, respectively, a coding distortion and a number of bits generated. The partial MPEG encoder 103 selects the code mode with the minimum RD cost for the current MB in the new resolution. If the final selected code mode is an inter mode, further ME refinement at quarter-pel resolution can be performed over a relative small search range, for example, +/−1 full-pel.

### 4. Architecture and Computer System for MPEG Video Resolution Reduction System

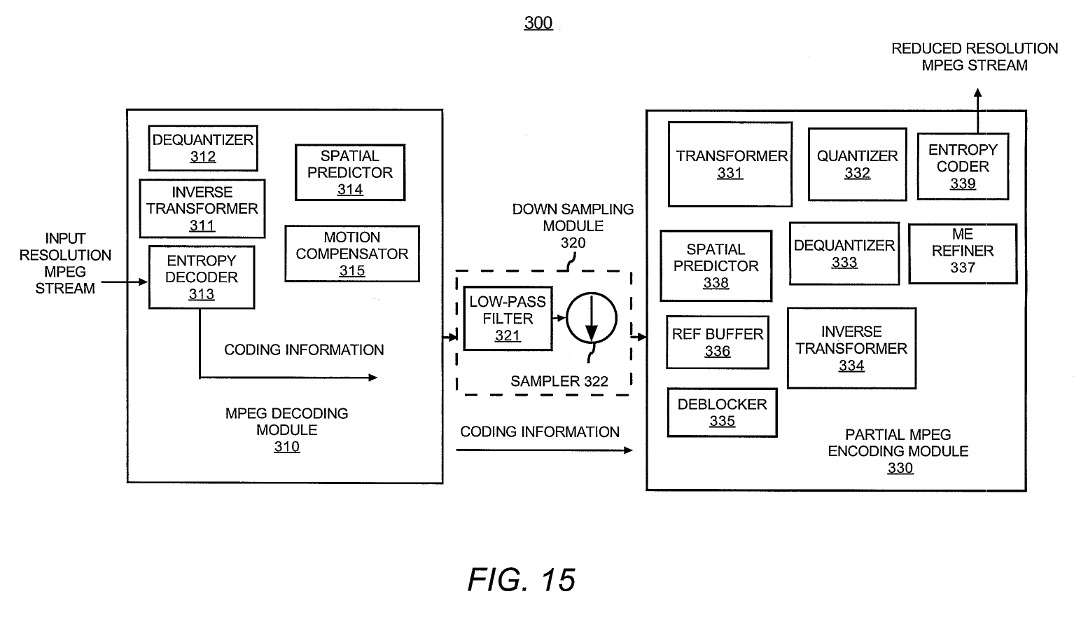

FIG. 15 illustrates a simplified block diagram of an architecture 300 of the MPEG video resolution reduction system 100 in which the methods 200-220 as described with respect to FIGS. 5 to 7 hereinabove may be implemented. The architecture 300 includes an MPEG decoding module 310, a down-sampling module 320 and a partial MPEG encoding module 330. The MPEG decoding module 310 is configured to decode an input resolution MPEG-4 part 10 stream to form an input resolution baseband. The down-sampling module 320 is configured to down-sample the input resolution baseband to form a reduced resolution baseband. The partial MPEG encoding module 330 is configured to encode the reduced resolution baseband to form a reduced resolution MPEG stream. The MPEG video resolution reduction system 300 is hardware that includes a circuit, for instance a processor, a memory, application specific integrated circuit (ASIC) or software code stored on a computer readable storage medium, configured to implement or execute one or more of the processes required to reduce the resolution of an input resolution MPEG stream depicted in FIGS. 5-7, according to an embodiment. It should be understood that the MPEG video resolution reduction system 300 depicted in FIG. 15 may include additional components and that some of the components described herein may be removed and/or modified without departing from a scope of the MPEG video resolution reduction system 300.

The MPEG decoding module 310 includes components that may be used to decode an MPEG stream. For instance, the first MPEG-4 part 10 decoding module 310 may include an inverse transformer 311, a dequantizer 312, an entropy decoder 313, a spatial predictor 314, and a motion compensator 315. By way of example, the inverse transformer 311 performs integer inverse transformation. The dequantizer 312, for instance, restores continuous variations of color in a quantized image. The entropy decoder 313 performs entropy decoding. The spatial predictor 314 performs predictions in pixel domain or spatial domain. The motion compensator 315 describes a current picture in terms of the transformation of a reference picture to the current picture.

The down-sampling module 320 includes components that may be used to down-sample an input resolution baseband to form a reduced resolution baseband. For instance, the down-sampling module 320 includes a low-pass filter 321 that may be used for low-passing the input resolution baseband and a sampler 322 that may be used for vertical and/or horizontal down-sampling.

The partial MPEG encoding module 330 includes components that may be used to encode an MPEG stream. For instance, the partial MPEG encoding module 330 may include a transformer 331, a quantizer 332, an entropy coder 339, an inverse quantizer 333, an inverse transformer 334, a deblocker 335, a ref buffer 336, an ME refiner 337, and a spatial predictor 338.

By way of example, the transformer 331 is a block transform. The block transform is an engine that converts a block of pixels, whereby the block may be a partition of a macroblock, in the spatial domain into a block of coefficients in the transform domain. The block transform tends to remove spatial correlation among the pixels of a block. The coefficients in the transform domain are thereafter highly de-correlated. The quantizer 332 assigns coefficient values into a finite set of values. Quantization is a lossy operation and the information lost due to quantization cannot be recovered. The entropy coder 339 performs entropy coding, which is a lossless coding procedure that removes statistical redundancy in input sequences. The deblocker 335 is a filter that is used for smoothing block boundaries. The ref buffer 336 holds data during the encoding process. The ME refiner 337 is used for ME refinement operations. The spatial predictor 338 performs predictions in pixel domain or spatial domain.

Embodiments of the present invention include an MPEG video resolution reduction system including a partial MPEG encoder. The reuse of coding decisions and coding statistics, which includes decisions on code modes and MVs for MPEG-4 part 10, in re-encoding an MPEG stream partial encoding used reduces encoding costs. For instance, the MPEG video resolution reduction system avoids implementing a complete encoding process, including ME, intra prediction, code mode selection, etc. Because of the resolution reduction, the coding information from the input resolution MPEG stream, such as decoded intra/inter modes, partition types, and MV(s) and refIdx, may not be directly re-used in encoding the reduced resolution baseband. Instead, embodiments of the invention provide methods for using the coding information from the input resolution MPEG stream to encode the reduced resolution baseband to form the reduced resolution MPEG stream.

Although described specifically throughout the entirety of the instant disclosure, representative embodiments of the present invention have utility over a wide range of applications, and the above discussion is not intended and should not be construed to be limiting, but is offered as an illustrative discussion of aspects of the invention.

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the embodiments of the invention.

What is claimed is:

1. An MPEG video resolution reduction system comprising:
an MPEG decoder including a circuit configured
to receive the input resolution MPEG stream,
to decode the input resolution MPEG stream to an input resolution baseband, and
to determine coding information from decoding the input resolution MPEG stream;
a down-sampler configured to down-sample the input resolution baseband to a reduced resolution baseband; and
a partial MPEG re-encoder configured to use the coding information to encode the reduced resolution baseband to a reduced resolution MPEG stream.

2. The MPEG video resolution reduction system of claim 1, wherein the partial MPEG re-encoder is configured to determine code modes and other coding parameters per macroblock (MB) in the reduced resolution MPEG stream based upon the coding information for corresponding MBs in the input resolution MPEG stream; and
to encode each MB in the reduced resolution baseband to the reduced resolution MPEG stream using the determined code modes and the other coding parameters per MB.

3. The MPEG video resolution reduction system of claim 2, wherein the partial MPEG re-encoder is further configured:
to determine for each MB in an area in the reduced resolution baseband whether there is an MB in intra mode in a corresponding area in the input resolution baseband;
in response to a determination that there is an MB in intra mode in the corresponding area in the input resolution baseband, to determine a coding cost for all allowable intra modes for the MB; and
to select an intra mode for the MB in the area in the reduced resolution baseband based on the coding cost.

4. The MPEG video resolution reduction system of claim 3, wherein the selected intra mode for the MB in the area in the reduced resolution baseband is a minimum coding cost intra mode.

5. The MPEG video resolution reduction system of claim 2, wherein the partial MPEG re-encoder is further configured:
to determine for each MB in an area in the reduced resolution baseband whether there is an MB in inter mode in a corresponding area in the input resolution baseband;
in response to a determination that there is an MB in inter mode in the corresponding area in the input resolution baseband, to determine a coding cost for all allowable inter modes in the reduced resolution baseband; and
to select an inter mode for the MB in the reduced resolution baseband based on the coding cost.

6. The MPEG video resolution reduction system of claim 5 wherein the selected inter mode for the MB in the area in the reduced resolution baseband is a minimum coding cost inter mode.

7. The MPEG video resolution reduction system of claim 5, wherein to determine the coding cost for an inter mode for the MB in the reduced resolution baseband, the partial MPEG re-encoder is configured to perform a motion estimation (ME) refinement using a starting MV for a current refIdx for the MB in the area in the reduced resolution baseband, wherein the starting MV is derived from decoded MVs and associated refIdx of the MBs in the corresponding area in the input resolution baseband.

8. The MPEG video resolution reduction system of claim 7, wherein the partial MPEG re-encoder is configured:
to determine whether the inter mode for the MB in the reduced resolution baseband is the inter mode of one of MBs in the corresponding area in the input resolution baseband; and
in response to a determination that the inter mode for the MB in the reduced resolution baseband is the inter mode of the one of MBs in the corresponding area in the input resolution baseband, to determine the starting MV for the current refIdx by scaling MV of the one of MBs in inter mode in the corresponding area in the input resolution baseband.

9. The MPEG video resolution reduction system of claim 7, wherein the partial MPEG re-encoder is configured:
to determine the starting MV for the current refIdx from a pool of the decoded MVs and associated refIdx of the MBs in the inter mode in the corresponding area in the input resolution baseband.

10. The MPEG video resolution reduction system of claim 5, wherein the corresponding area in the input resolution baseband covers a plurality of MBs.

11. The MPEG video resolution reduction system of claim 1, wherein the input MPEG stream is an MPEG-4 part 10 stream.

12. A method for reducing a resolution of an input resolution MPEG stream, the method comprising:
receiving the input resolution MPEG stream;
decoding the input resolution MPEG stream to an input resolution baseband; wherein the decoding is performed by a circuit; and
determining coding information from decoding the input resolution MPEG stream;
down-sampling the input resolution baseband to a reduced resolution baseband; and
encoding the reduced resolution baseband to a reduced resolution MPEG stream using the coding information.

13. The method of claim 12, further comprising:
determining code modes and other coding parameters per MB in the reduced resolution MPEG stream based upon the coding information for corresponding MBs in the input resolution MPEG stream; and
encoding each MB in the reduced resolution baseband to the reduced resolution MPEG stream using the determined code modes and the other coding parameters per MB.

14. The method of claim 13, further comprising:
determining for each MB in an area in the reduced resolution baseband whether there is an MB in intra mode in a corresponding area in the input resolution MPEG stream;
in response to a determination that there is an MB in intra mode in the corresponding area in the input resolution baseband, determining a coding cost for all allowable intra modes for the MB in the reduced resolution baseband; and
selecting an intra mode for the MB in the reduced resolution baseband based on the coding cost.

15. The method of claim 14, further comprising:
selecting a minimum coding cost intra mode for the intra mode for the MB in the area in the reduced resolution baseband.

16. The method of claim 13, further comprising:
determining for each MB in an area in the reduced resolution baseband whether there is an MB in inter mode in a corresponding area in the input resolution baseband;
in response to a determination that there is an MB in inter mode in the corresponding area in the input resolution baseband, determining a coding cost for all allowable inter modes for the MB in the reduced resolution baseband; and
selecting an inter mode for the MB in the reduced resolution baseband based on the coding cost.

17. The method of claim 16, further comprising:
performing an ME refinement using a starting MV for a current refIdx for the MB in the area in the reduced resolution baseband, wherein the starting MV is derived from decoded MVs and associated refIdx of the MBs in the corresponding area in the input resolution baseband.

18. The method of claim 17, further comprising:
determining whether the inter mode for the MB in the reduced resolution baseband is the inter mode of one of MBs in the corresponding area in the input resolution baseband; and
in response to a determination that the inter mode for the MB in the reduced resolution baseband is the inter mode of the one of MBs in the corresponding area in the input resolution baseband, determining the starting MV for the current refIdx by scaling MV of the one of MBs in inter mode in the corresponding area in the input resolution baseband.

19. A computer readable storage medium storing at least one computer program that when executed by a computer system performs a method comprising:
receiving the input resolution MPEG stream;
decoding the input resolution MPEG stream to an input resolution baseband; and
determining coding information from decoding the input resolution MPEG stream;
down-sampling the input resolution baseband to a reduced resolution baseband; and
encoding the reduced resolution baseband to a reduced resolution MPEG stream using the coding information.

20. The method stored on the computer readable storage medium of claim 19, further comprising:
determining code modes and other coding parameters per MB in the reduced resolution MPEG stream based upon the coding information for corresponding MBs in the input resolution MPEG stream; and
encoding each MB in the reduced resolution baseband to the reduced resolution MPEG stream using the determined code modes and the other coding parameters per MB.
